(19) United States
(12) Patent Application Publication
(10) Pub. No.: US 2004/0101386 A1
(43) Pub. Date: May 27, 2004

(54) Vertical carousel with top and side access stations

(75) Inventor: Timothy Robey, Windham, ME (US)

Correspondence Address: CROWELL & MORING LLP, INTELLECTUAL PROPERTY GROUP, P.O. BOX 14300, WASHINGTON, DC, 20044-4300, US

(73) Assignee: Bellheimer Metallwerk GmbH

(21) Appl. No.: 10/301,743

(22) Filed: Nov. 22, 2002

(51) Int. Cl. B65G 1/12

(52) U.S. Cl. 414/331.1

(57) ABSTRACT

A vertical carousel which has an access station located at the top of the machine, for access to the stored products from automated mechanisms from above rather than the side of the machine. Product can then be easily accessed via common overhead transport vehicles, such as those used in the semiconductor industry, and also can be stored one behind the other and still provide easy access.

### BACKGROUND OF THE INVENTION

Conventional vertical carousel systems typically include one or more machines with storage carriers, and one or more points of access to the carriers in order for operators to store and retrieve product to and from the storage carriers. These access points are typically placed in a position on the front and/or the rear face of the carousel, allowing operators to push product onto the carrier or to pull it off, as shown in U.S. Pat. No. 5,902,027. Occasionally, these vertical carousel systems are utilized in automated environments, where robotic mechanisms store and retrieve products to and from the carrier, in a manner similar to that of a human operator, i.e. via side access stations on a front and/or a rear face of the carousel.

### SUMMARY OF THE INVENTION

An object of the present invention is to provide an improved method for automated robotic access to the carousel.

This object has been achieved in accordance with the present invention by providing an access station at the top of the carousel, rather than the front or rear side, allowing a robotic mechanism to lift and lower product on and off from a carrier, instead of pushing and pulling it from a front or a rear face.

According to another important aspect of the present invention, a top access station allows relatively easy access to stored products that are placed one behind the other, by simply indexing the carousel to alternate stop positions for the carrier, or indexing the robot mechanism to alternate positions. With the traditional method of robots on the front and/or rear face of the machine, access to product one behind the other creates the necessity for a relatively complicated mechanism, to provide access to all parts in the row.

According to another important aspect of the present invention, traditional overhead transport vehicles can be employed to directly access product on the top access point of the carousel. This eliminates the need to create specialized mechanisms for automated access.

A significant advantage of the present invention is its flexibility at minimum constructional cost, since expensive workstations (with personnel safeguarding devices) for operators can be eliminated, and standard robotic mechanisms can be employed.

Of course, combinations of workstations, both manual and automatic, and top and side, on the same machine, are contemplated and described with this invention.

### BRIEF DESCRIPTION OF THE DRAWINGS

Other objects, advantages and novel features of the present invention will become apparent from the following description of the invention when considered in conjunction with the following referenced figures.

FIG. 1 is a side view of a vertical carousel system, showing a top access point and an automated transport car supported by a monorail.

FIG. 1A is a side view detail of the top access area showing a container being removed or loaded from/to the vertical carousel system pictured in FIG. 1.

FIG. 2 is a side view showing a vertical carousel system like that in FIG. 1, but with the carousel's stop position indexed to a different position to provide access to a container stored behind another.

FIG. 3 is a perspective view of a vertical carousel system, showing a top access point and an automated transport car supported by a section of monorail.

FIG. 4 is a perspective view of a vertical carousel showing a side access station on a front face of the carousel, and an overhead transport vehicle for automated access to the stored containers.

FIG. 5 is side view of the vertical carousel shown in FIG. 4.

FIG. 6 is a side view of another embodiment of a vertical carousel having a side access station on the front face of the carousel, and an overhead transport vehicle with a side reaching extension for access to the stored products.

FIG. 7 is a side view of another embodiment of a vertical carousel having a top access with a common queue area between overhead transport vehicles.

### DETAILED DESCRIPTION OF THE DRAWINGS

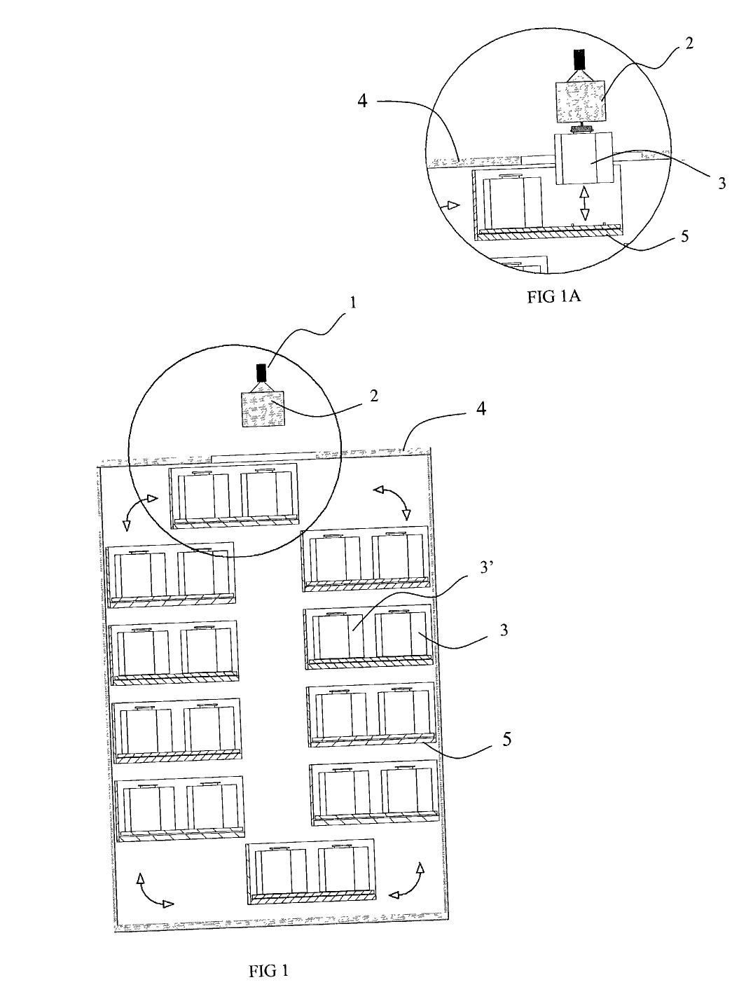

FIG. 1 is a side view of a vertical carousel system (4), showing a top access point and an automated transport vehicle (2) supported by a monorail (1). The carousel (1) includes one or more carriers (5) which rotate around an elliptical path as shown by the arrow references in the corner sections of the illustration. The carriers (5) in this illustration carry stored product (3, 3′) to a point of access at the top of the machine, where the robotic mechanism can extract them for carriage to another location within its movable area in the facility. This illustration shows five containers times two rows, but other variations are contemplated and within the ordinary skill of those in the art. The carousel drive mechanism delivers the desired carrier to one of multiple (two in this example) stop positions, for access to the rows of product (3, 3′) contained on the carrier (5).

FIG. 1A is a side view detail of FIG. 1 showing the transport vehicle (2) raising or lowering a storage container (3) from/to the carrier (5) within the carousel (4).

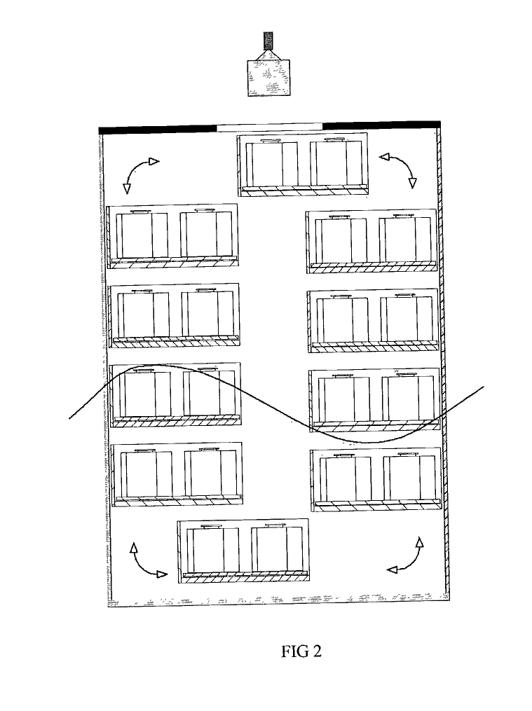

FIG. 2 shows the same machine as FIG. 1, but demonstrates the secondary stop position for access to the second row of stored product.

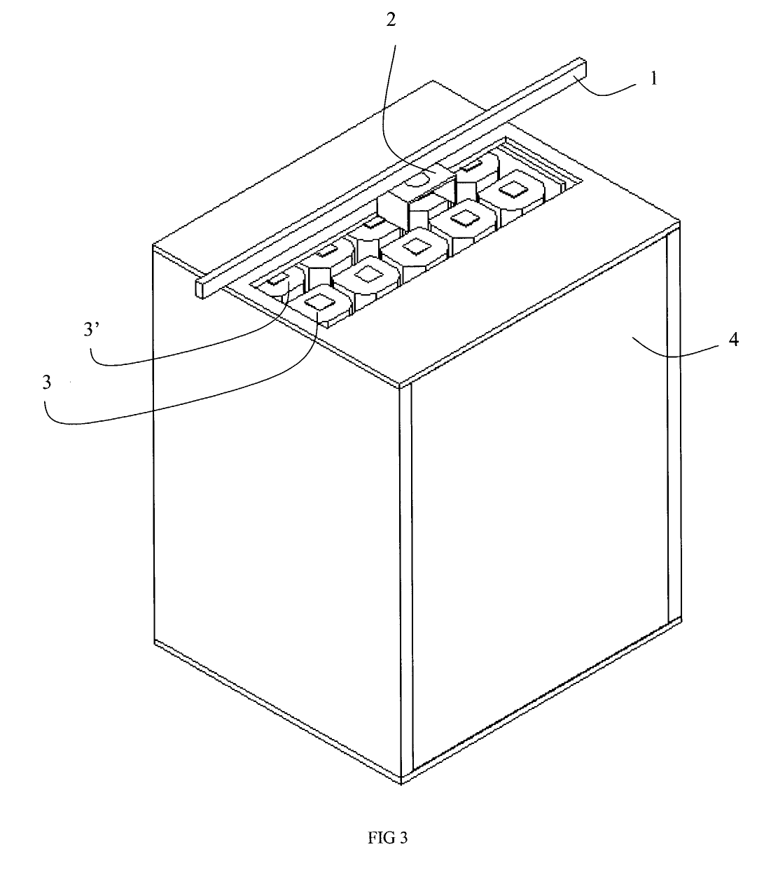

FIG. 3 shows a perspective view a vertical carousel (4), an overhead transport vehicle (2) riding on a monorail (1), positioned for access to storage containers (3, 3′) at a top access station.

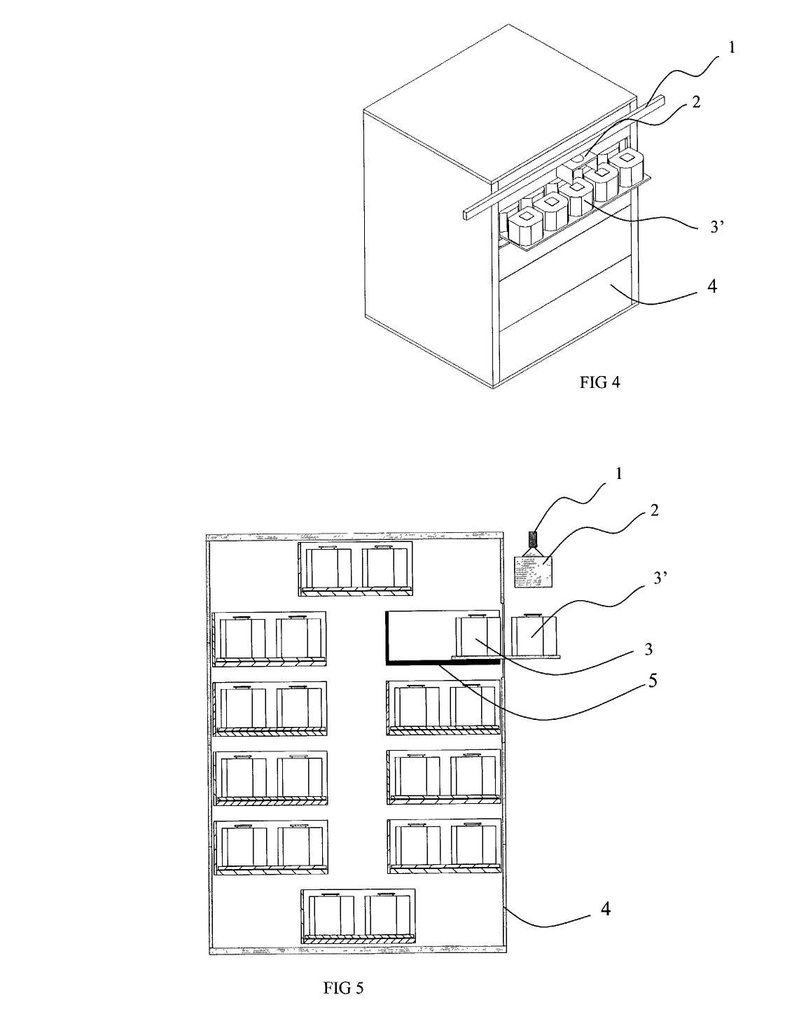

FIG. 4 is a perspective view of a vertical carousel (4), an overhead transport vehicle (2) riding on a monorail (1) for access to product (3′) from a front face of the carousel.

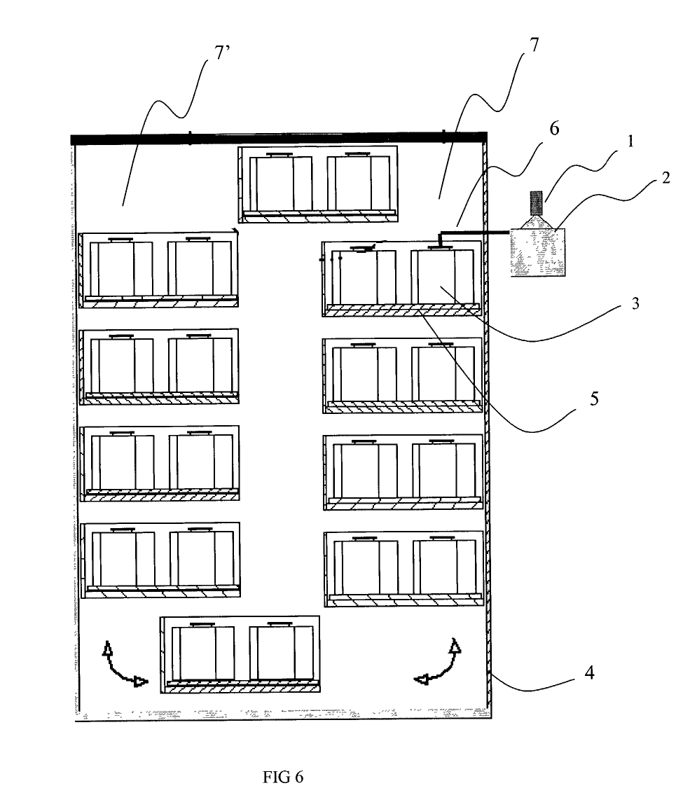

FIG. 5 is a side view of the vertical carousel from FIG. 4, showing a carrier (5) stopped in an access position for delivery of product to the overhead transport vehicle (2). This figure demonstrates one of multiple (two in this example) drawer extension positions which are delivered for access to the multiple depth locations for the product. Of course, the drawer would be extendable out to a second position (not shown) for access to the back row in this example.

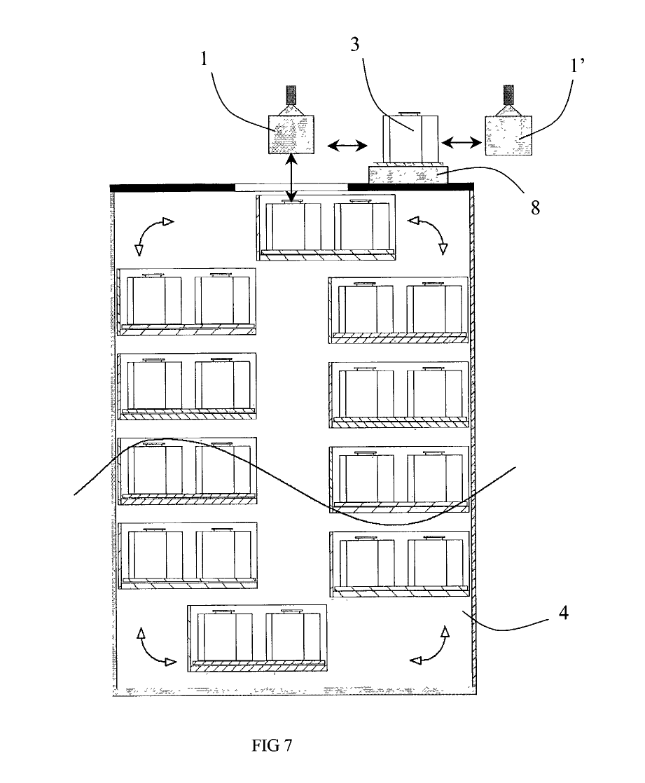

FIG. 6 is a side view of a vertical carousel (4) showing a side access station on the front face of the carousel, and an overhead transport vehicle (2) with a side reaching mechanized extension (6) for access to the stored products contained within the carriers (5). This concept could also be applied to the rear face of the carousel, for access to the rear row of stored products in a similar, but reversed, manner within the ordinary skill of those in the art. The position of the carrier (5) at the access point is not randomly placed, but intentionally shown in the upper section of the vertical guidance path, where space above the stored product on the front face (7) and the rear face (7′) becomes available due to the top carrier pulling away to move through the radius at the top of the machine. Other positions in the vertical path are of course contemplated, but not illustrated as they are considered well within the ordinary skill of those in the art.

FIG. 7 is a side view of a vertical carousel (4) showing a top access station with an overhead transport vehicle (1) which serves to provide direct access to stored contents on the movable carriers, and a common queue staging station (8) between another overhead transport vehicle (1′) for passing contents (3) between the vehicles. This has the significant advantage of increasing access throughput speed by creating a staging area that can be loaded and unloaded by a carousel serving vehicle (1) whenever the carousel (4) has delivered the selected carrier for access to the contents stored thereon or containing vacancies for loading, essentially eliminating the carousel's typical dwell time associated with waiting for vehicles to serve the carousel. Other overhead transport vehicles can then, access the contents from the queue whenever they become available at the queueing station. The queueing station can span multiple carousels, and can be motorized such as that of conventional conveyor belt systems, and could also be considered for side loading stations in a similar manner. The queueing stations can also provide similar benefit for a single monorail station, by assigning an overhead transport vehicle to serve the carousel when deemed appropriate by system throughput load demands, and then moving the overhead transport vehicle out of the way to provide access to the queue by other vehicles as they become available at the carousel station.

While I have shown and described several embodiments in accordance with the present invention, it is to be clearly understood that the present invention is not limited thereto. The present invention contemplates all changes and modifications that are encompassed by the scope of the appended claims.

What is claimed is:

1. A vertical carousel system, comprising at least one movable storage carrier and an access position to access stored contents of the at least one movable storage carrier located at the top of the machine.

2. The system according to claim 1, wherein a mechanism for accessing the stored content(s) is on overhead transport vehicles conventionally used in semiconductor fabrication.

3. The system according to claim 1, wherein the contents contained on the at least one movable storage carrier are placeable one behind the other on the carrier as well as side-by-side thereon.

4. The system according to claim 1, wherein the at least one movable storage carrier is arranged to be indexed to a desired stop position based on which of the stored contents is to be is to be selected and the depth position associated therewith.

5. The system according to claim 1, where at least two overhead transport vehicle tracks are placed above the carousel, and the at least one movable storage carrier is arranged to be accessible from a desired vehicle based on a requirement established by a managing computer system.

6. The system according to claim 1, further comprising a robotic extraction mechanism arranged to be indexed to a correct stop position based on which of the stored contents is to be selected and a width position associated therewith.

7. A method using the system according to claim 1, comprising storing and retrieving wafers, reticules, and other containers used in semiconductor manufacturing, to and from the at least one movable storage carrier.

8. A vertical carousel system, comprising at least one movable storage carrier and an access location for access at the top of a machine housing, to contents of the at least one movable storage carrier, a mechanism for accessing the stored contents consisting of conventional overhead transport vehicles wherein the product contained on the at least one movable carrier is placed one behind the other on the carrier, as well as side-by-side, thereon the at least one movable carrier is indexed to a desired stop position based on which product is to be selected and the depth position therewith.

9. The system according to claim 8, wherein at least two overhead transport vehicle tracks are placed above the carousel, and the at least one movable carrier is positioned for access from any vehicle based on at least one requirement established by a managing computer system.

10. The system according to claim 8, wherein the mechanism is a robotic extraction mechanism configured to be indexed to a desired stop position based on which of the contents is to be selected and the width position associated with the selection.

11. A vertical carousel system, comprising at least one movable storage carrier, a position of access to stored contents of the at least one movable storage carrier located at at least one of a front and a rear face of the machine, a mechanism for accessing the stored contents configured as overhead transport vehicles conventionally used in semiconductor fabrication, equipped with side-loading mechanisms so as to be able to reach in and lift out a storage container, or to access a drawer which has been automatically extended, from either the front or the rear face of the machine, and at least one depth position on the at least one movable storage carrier is reserved for placement of storage containers, wherein a front tracking overhead transport vehicle manipulates a front row while a rear tracking overhead transport vehicle manipulates a rear row.

12. A vertical carousel system, comprising at least one movable storage carrier and a position of access to stored contents of the at least one movable storage carrier at at least one of top, front face and rear face of a housing, and a queueing station that serves as a common holding area for at least one product container, to allow the carousel operatively arranged in the housing to process commands to access stored contents for filling a queue of storage containers by removing contents from the at least one movable storage carrier, or emptying the queue of storage containers by removing contents from the queue and loading the contents onto vacancies within the at least one movable storage carrier, enabling selected containers to be available to at least one overhead transport vehicle as they arrive at a carousel staging area, as well as multiple vacancies for drop off and carousel loading at lower demand times from a track of the at least one overhead transport vehicle.
